(19) United States
(12) Patent Application Publication
(10) Pub. No.: US 2005/0102461 A1
(43) Pub. Date: May 12, 2005

(54) Separable multi-interface I/O card device

(75) Inventors: Jui-Chung Chen, Cishan Township (TW); Jung-Ta Chang, Jhudong Township (TW); Caph Chen, Kaohsiung City (TW); Sidney Young, Hsinchu City (TW)

Correspondence Address: BACON & THOMAS, PLLC, 625 SLATERS LANE, FOURTH FLOOR, ALEXANDRIA, VA, 22314, US

(73) Assignees: C-One Technology Corporation, Hsin-Chu City (TW); Pretec Electronics Corporation, Fremont, CA (US)

(21) Appl. No.: 10/914,146

(22) Filed: Aug. 10, 2004

(30) Foreign Application Priority Data
Nov. 12, 2003 (TW) 092131731

(51) Int. Cl. G06F 13/00

(52) U.S. Cl. 710/306

(57) ABSTRACT

A separable multi-interface I/O card device comprises an I/O bridge and an I/O device. The I/O bridge includes a host interface for coupling to an electronic device, a bridge unit, and a first I/O bus, wherein the bridge unit is adapted to either convert signals from the host interface into signals of the first I/O bus or convert signals from the first I/O bus into signals of the host interface, and supply power from a power pin of the host interface to the first I/O bus. The I/O device includes an I/O functional unit and a second I/O bus mated with and separably coupled to the first I/O bus so as to send power, I/O, data, and control signals from the host interface to the I/O functional unit.

### BACKGROUND OF THE INVENTION

1. Field of the Invention

The present invention relates to an electronic card, and, more particularly, to a separable multi-interface I/O card device.

2. Description of Related Art

As a result of electronic advancements, a wide variety of miniature electronic devices (e.g., notebook computers, palm computers, PDAs (Personal Digital Assistants), or DSCs (digital still cameras)) are available. Such small and compact electronic devices can bring much convenience to uses due to its portability. However, such electronic devices can only provide basic features due to the limitation of their size. Typically, a port is provided on the electronic device so that one of a variety of electronic cards is adapted to couple thereto for enhancing functions of the electronic device.

Currently, a variety of ports (e.g., CF, SD, USB (Universal Serial Bus), MS, PCMCIA (Personal Computer Memory Card International Association), Cardbus, Express Card, New Card, iDisk, iDisk Tiny, etc.) are provided on an electronic device. Thus, electronic card manufactures have to produce many electronic cards having different connectors for respectively coupling to one of a variety of electronic devices having different ports. Further, in consideration of electronic cards having different functions (e.g., memory cards, GPS (Global Positioning System) cards, GPRS (General Packet Radio Service) cards, modem cards, etc.), the problem will be even worse since electronic card manufactures have to produce many more electronic cards having different connectors. For example, for coupling to each of M electronic devices having N different ports, N×M electronic cards are required to produce.

It is understood that port specifications of electronic devices change rapidly. Hence, an electronic card may be quickly phased out due to the change of port specifications of the electronic device. Unfortunately, a user has to buy a new electronic card having the same features as the discarded one but only having a different connector specification. This is a waste. Thus, the need for the improvements of electronic cards still exists in order to mitigate and/or obviate the aforementioned problems.

### SUMMARY OF THE INVENTION

An object of the present invention is to provide a separable multi-interface I/O card device, which can combine different electronic card interfaces with different I/O devices, so as to reduce the time spent on developing electronic cards and the cost of buying electronic cards.

To achieve the above and other objects, the separable multi-interface I/O card device of the present invention comprises: an I/O bridge including a host interface for coupling to an electronic device, a bridge unit, and a first I/O bus, wherein the bridge unit is adapted to either convert signals from the host interface into signals of the first I/O bus or convert signals from the first I/O bus into signals of the host interface, and supply power from a power pin of the host interface to the first I/O bus; and an I/O device including an I/O functional unit and a second I/O bus mated with and separably coupled to the first I/O bus so as to send power, I/O, data, and control signals from the host interface to the I/O functional unit.

Other objects, advantages, and novel features of the invention will become more apparent from the detailed description when taken in conjunction with the accompanying drawings.

### BRIEF DESCRIPTION OF THE DRAWINGS

FIG. 1 schematically depicts a block diagram of a first preferred embodiment of separable multi-interface I/O card device according to the invention;

FIG. 2 schematically depicts details of the I/O bridge;

FIG. 3 schematically depicts details of the I/O device;

FIG. 4 is a perspective view schematically showing two I/O buses to be coupled together;

FIGS. 5A and 5B schematically depicts contact arrangements of top and bottom sides of the I/O bus; and

FIG. 6 schematically depicts a block diagram of a second preferred embodiment of separable multi-interface I/O card device according to the invention.

### DETAILED DESCRIPTION OF THE PREFERRED EMBODIMENT

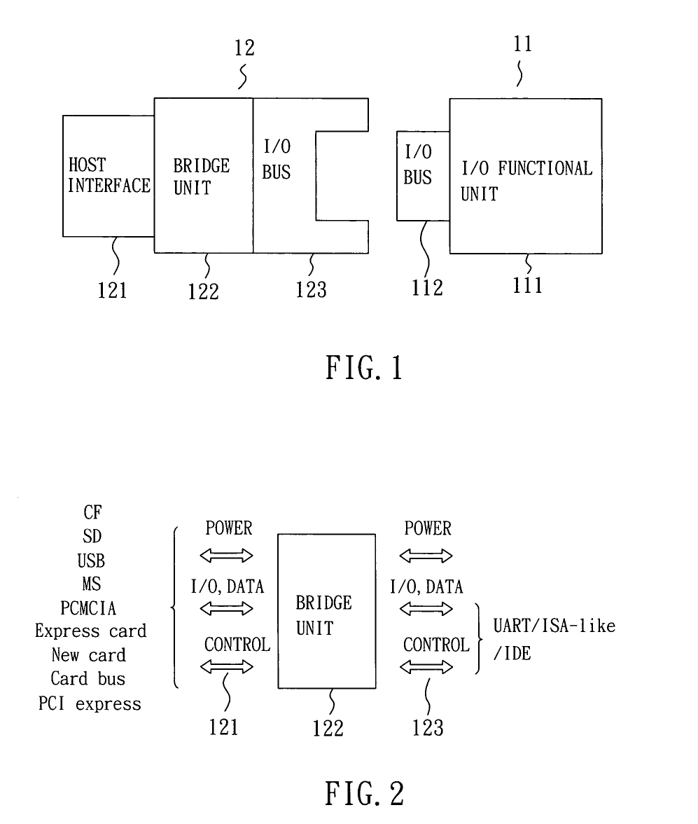

With reference to FIG. 1, there is shown a schematic block diagram of a first preferred embodiment of separable multi-interface I/O card device according to the invention. The separable multi-interface I/O card device comprises an I/O device 11 and an I/O bridge 12 separably and electrically coupled to the I/O device 11. The I/O device 11 comprises an I/O functional unit 111 and an I/O bus 112. The I/O bridge 12 comprises a host interface 121, a bridge unit 122, and an I/O bus 123. The I/O bus 123 and the I/O bus 112 are mated so that the I/O bridge 12 is adapted to couple to the I/O device With reference to FIG. 2, it schematically depicts details of the I/O bridge 12. The bridge unit 122 is adapted to either convert signals (including power, I/O, data, and control signals) from the host interface 121 into signals (including power, I/O, data, and control signals) of the I/O bus 123 and thus the I/O bus 112, or convert signals from the I/O bus 123 into the signals of the host interface 121. The host interface 121 is implemented as a standard interface such as CF (50-pin), SD (9-pin), USB, MS, PCMCIA, Express Card, New Card, Card Bus, or PCI (Peripheral Component Interconnect) express, or as a self-defined interface (e.g., iDisk, iDisk Tiny, etc.). Each of such interfaces has power, I/O, data, and control pins so as to couple to a mated port of an electronic device (not shown). In the embodiment, the I/O bus 123 is a serial UART (Universal Asynchronous Receiver/Transmitter) bus which has I/O, data, and control pins but without a power pin. Thus, the bridge unit 122 has to supply power from the power pin of the host interface 121 to the I/O bus 123. A table of exemplary pin assignments of the I/O bus 123 is as follows:

UART Bus:

| | | | Internal | |
|---|---|---|---|---|
| Pin No. | Pin Name | Type | Resistor | Description |
| 1 | RTS# | O | | Request To Send Control |
| 2 | DTR# | O | | Data Terminal Ready Control |
| 3 | Sₒᵤₜ | O | | Transmit Asynchronous Data |
| 4 | Sᵢₙ | I | | Receive Asynchronous Data |
| 5 | CTS# | I | | Clear To Send Control |
| 6 | DSR# | I | | Data Set Ready Control |
| 7 | DCD# | I | | Data Carrier Detact Control |
| 8 | RI# | I | | Ring Indicator Control. When the |
| | | | | Remote Wakeup function is |
| | | | | enabled, taking RI# low can |
| | | | | be used to resume the PC Host |
| | | | | controller from suspend |
| 9 | VCC | PWR | | Provide +3.3 volt VCC to |
| | | | | the legacy serial peripheral |
| 10 | Resv | — | | Reserved pin for future use |
| 11 | Resv | — | | Reserved pin for future use |
| 12 | GND | PWR | | Ground |

As shown, pins 1 to 8 are used by a standard UART bus, pins 9 and 12 are power pins 10 and 11 are reserved for future use such as data pins D+ and D− of USB. In other embodiments, the I/O bus 123 is a parallel bus such as IDE (Integrated Drive Electronics) or ISA (Industry Standard Architecture)-like bus.

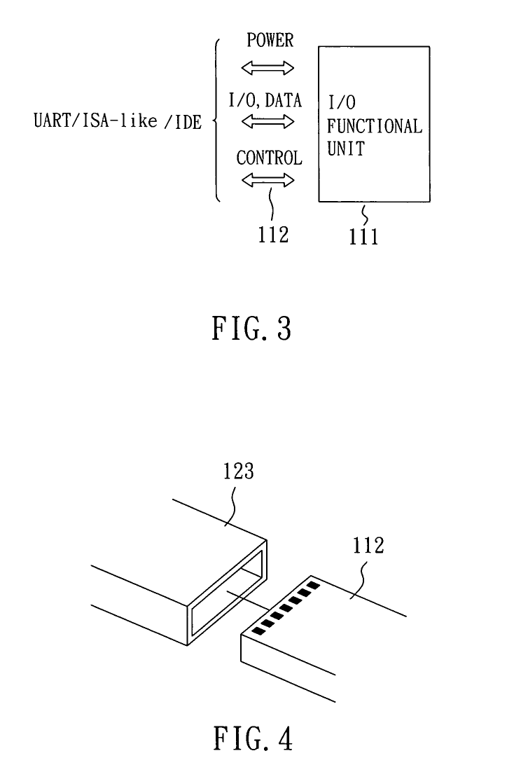

With reference to FIG. 3, it schematically depicts details of the I/O device 11. The I/O functional unit 111 is a chip module (e.g., GPS module, GPRS module, bluetooth module, or modem module) for providing an I/O function to the electronic card. The I/O bus 112 is a UART serial bus mated with the I/O bus 123. The I/O bus 112 has I/O, data, and control pins but without a power pin. Thus, the bridge unit 122 has to supply power from the power pin of the host interface 121 to the I/O bus 112 via the I/O bus 123. For example, 5V/3.3V of CF port is adapted to supply 3.3V±5%, 2.0 to 3.6V/3.1 to 3.5V of SD port is adapted to supply 3.3V±5%, or 4.25V to 5.25V of USB port is adapted to supply 3.3V±5% for maintaining a normal operation of the I/O functional unit 111 of the I/O assembly 11.

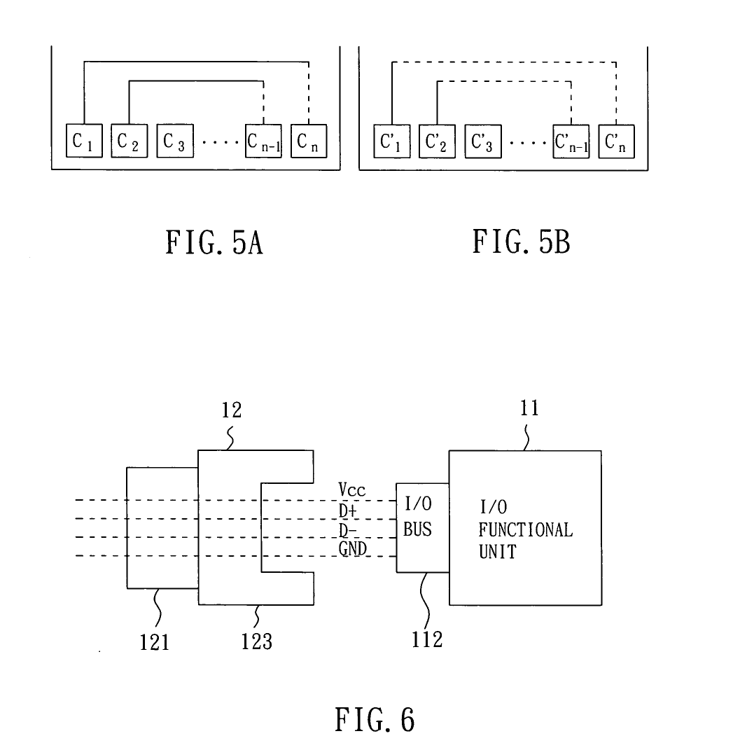

As stated above, the I/O bus 112 is mated with the I/O bus 123. With reference to FIG. 4, it shows that the I/O bus 123 and the I/O bus 112 are adapted to couple together. Preferably, the I/O bus 123 is a female connector and the I/O bus 112 is a male connector. With reference to FIGS. 5A and 5B, contact arrangements of top and bottom sides of the I/O bus 112 as illustrated. As shown in FIG. 5A, a plurality of contacts (C1, C2, C3, . . . , Cn-1, and Cn) are arranged in a straight line on the top side of the I/O bus 112. Also, as shown in FIG. 5B, a plurality of contacts (C1′, C2′, C3′, . . . , Cn-1′, and Cn′) are arranged in a straight line on the bottom side of the I/O bus 112. Contact Ci′ is disposed correspondingly to the contact Cn−i+1. The contact Ci′ is electrically coupled to the contact Ci. In other words, the contacts on the top side of the male connector are symmetric with respect to that on the bottom side thereof. By configuring as above, either top or bottom side of the I/O bus 112 is adapted to insert into the I/O bus 123 for electrical coupling. That is, the I/O device 111 is adapted to couple to the I/O bridge 12 without considering the orientation (i.e., top or bottom side) thereof.

With reference to FIG. 6, it schematically depicts a block diagram of a second preferred embodiment of separable multi-interface I/O card device according to the invention. The I/O bus 112 of the I/O device 11 is a USB bus having D+, D−, Vcc and GND pins. The host interface 121 of the I/O bridge 12 is also a USB connector. Hence, the bridge unit 122 is eliminated from the I/O bridge 12. Instead, the USB pins of the host interface 121 are coupled to the I/O bus 112 having the same USB bus via the I/O bus 123.

In brief, the invention contemplates the I/O device and the I/O bridge of the separable multi-interface I/O card device as independent modules. Therefore, an I/O device with a specific function can be combined with various kinds of I/O bridge via mated I/O buses, thereby providing a electronic card device with desired interface and function to meet with electronic device with a corresponding connector. The user can replace the I/O bridge of the electronic card device based on the actual requirement, so as to reduce the time spent on developing electronic cards and the cost of buying electronic cards.

Although the invention has been explained in relation to its preferred embodiment, it is to be understood that many other possible modifications and variations can be made without departing from the spirit and scope of the invention as hereinafter claimed.

1. A separable multi-interface I/O card device, comprising:
an I/O bridge including a host interface for coupling to an electronic device, a bridge unit, and a first I/O bus, wherein the bridge unit is adapted to either convert signals from the host interface into signals of the first I/O bus or convert signals from the first I/O bus into signals of the host interface, and supply power from a power pin of the host interface to the first I/O bus; and
an I/O device including an I/O functional unit and a second I/O bus mated with and separably coupled to the first I/O bus so as to send power, I/O, data, and control signals from the host interface to the I/O functional unit.

2. The separable multi-interface I/O card device as claimed in claim 1, wherein the I/O functional unit is an I/O chip module.

3. The separable multi-interface I/O card device as claimed in claim 1, wherein the first I/O bus is a female connector and the second I/O bus is a male connector.

4. The separable multi-interface I/O card device as claimed in claim 3, wherein the male connector comprises a plurality of first contacts Ci arranged in a straight line on a top side and a plurality of second contacts Ci′ arranged in a straight line on a bottom side, the contact Ci′ being disposed correspondingly to the contact Cn-i+1, the contact Ci′ being electrically coupled to the contact Ci, and n being the number of the first or second contacts.

5. The separable multi-interface I/O card device as claimed in claim 1, wherein each of the first and second I/O buses is a UART serial bus.

6. The separable multi-interface I/O card device as claimed in claim 1, wherein each of the first and second I/O buses is an IDE parallel bus.

7. The separable multi-interface I/O card device as claimed in claim 1, wherein each of the first and second I/O buses is an ISA-like parallel bus.

8. The separable multi-interface I/O card device as claimed in claim 1, wherein the host interface is a CF, SD, USB, MS, PCMCIA, Express Card, New Card, Card Bus, or PCI express.

9. The separable multi-interface I/O card device as claimed in claim 1, wherein the bridge unit supplies a predetermined voltage to the I/O functional unit of the I/O device.

10. The separable multi-interface I/O card device as claimed in claim 9, wherein the predetermined voltage is either 3.3V±5% or 5V±5%.
